(19) United States
(12) Patent Application Publication
(10) Pub. No.: US 2010/0091864 A1
(43) Pub. Date: Apr. 15, 2010

(54) Moving-image-similarity determination device, encoding device, and feature calculating method

(75) Inventors: Atsuko Tada, Kawasaki (JP); Takashi Hamano, Kawasaki (JP); Ryuta Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/591,950

(22) Filed: Dec. 4, 2009

Related U.S. Application Data
(63) Continuation of application No. PCT/JP2007/061580, filed on Jun. 7, 2007.

(51) Int. Cl. H04N 7/26

(52) U.S. Cl. 375/240.16; 375/E07.125

(57) ABSTRACT

A moving-image similarity determination device includes an acquiring unit that acquires a frame included in moving image data obtained by encoding a moving image including a plurality of images, the frame corresponding to an individual image of the plurality of images; a calculating unit that calculates a feature value indicating complexity of an original image of the frame based on a data amount of the frame acquired by the acquiring unit and on a quantization step used upon encoding; an accumulating unit that accumulates the feature value calculated for each image by the calculating unit; and a determining unit that that determines whether two moving images are similar to each other by comparing the feature values accumulated by the accumulating unit.

### CROSS-REFERENCE TO RELATED APPLICATION(S)

This application is a continuation of International Application No. PCT/JP2007/061580, filed on Jun. 7, 2007, the entire contents of which are incorporated herein by reference.

### FIELD

The embodiments discussed herein are directed to a moving-image-similarity determination device, an encoding device, and a feature calculating method.

### BACKGROUND

Generally, moving image data that can be viewed on a computer and the like are encoded and compressed, for example, in a format called the moving picture experts group (MPEG) format. In the MPEG format, by performing discrete cosine transform (DCT) on each image constituting a moving image and quantizing the obtained DCT coefficients, encoded moving image data are obtained.

Specifically, by sequentially performing DCT on each image constituting a moving image by an encoding device as illustrated in FIG. 8, an image of DCT coefficients in which low-frequency components are collected at an upper left part and high-frequency components are collected at a lower right part is generated. This image of DCT coefficients corresponds to each image constituting the moving image, and a DCT coefficient of each frequency component is stored in each pixel.

The image of DCT coefficients is quantized by a quantization matrix and a quantization coefficient acquired from a predetermined quantization step, to obtain moving image data. In the moving image data thus obtained, most of pixels storing high-frequency components become 0, and therefore, information volume of data of the moving image data becomes smaller than that of the original moving image, and reduction in the information volume is possible.

Only some of the images constituting the original moving image are encoded in their entirety as described above. The result of encoding is a frame called “I frame”. A “P frame” and a “B frame” are frames in which differences from the I frame are encoded. Therefore, in the P frame and B frame, the pixel having no movement from the I frame becomes 0, and thus it is possible to reduce the information volume from the original moving image for the finally obtained entire moving image data significantly.

A technique of determining whether two moving image data encoded as above are similar to each other by comparing them is disclosed in Japanese Laid-open Patent Publication No. 2006-18831, for example. In this technique, the moving image data are partially decoded, and a feature value such as an average brightness, color information, a DCT coefficient, or the like for each pixel is chronologically accumulated, and by comparing these feature values of the two moving image data, the determination of whether the two moving image data are similar to each other is made.

However, in the determination of whether the two moving image data are similar to each other, obtaining the feature value of each pixel from each moving image data increases the processing load and decreases the efficiency. Specifically, when the similarity between the moving image data is determined using the method described in the above patent document, the quantization coefficient is to be acquired from the quantization matrix and the quantization step. By performing inverse quantization on the moving image data using the acquired quantization coefficient, the DCT coefficient is acquired. The DCT coefficient thus acquired is the feature value of each pixel, and in the technique disclosed in the above patent document, the DCT coefficients are chronologically accumulated to be compared between the two moving image data. Therefore, a lot of processing that consumes much time is to be performed for this similarity determination.

Particularly, in the MPEG format, one I frame includes a plurality of portions called macro blocks, and because each macro block is quantized by a different quantization step, the quantization coefficient is to be acquired individually for each macro block. Further, the DCT coefficient as the feature value is to be calculated by performing inverse quantization using the quantization coefficient for each macro block. Therefore, even if only some of the macro blocks are to be compared, a lot of processing is to be performed for the calculation of the quantization coefficients and the calculation of the DCT coefficients, and the similarity determination in a short period of time is difficult.

In addition, sites for allowing users to post moving image data over the Internet have been established recently, and use of moving image data has been activated. However, illegal use of moving images such as posting of moving image data to be protected by copyright to such sites has occurred frequently. Therefore, it is desirable to determine in a short period of time, for a great number of moving images, whether the moving images are similar, to prevent moving images from being made public illegally.

### SUMMARY

According to an aspect of an embodiment of the invention, a moving-image similarity determination device includes: an acquiring unit that acquires a frame included in moving image data obtained by encoding a moving image including a plurality of images, the frame corresponding to an individual image of the plurality of images; a calculating unit that calculates a feature value indicating complexity of an original image of the frame based on a data amount of the frame acquired by the acquiring unit and on a quantization step used upon encoding; an accumulating unit that accumulates the feature value calculated for each image by the calculating unit; and a determining unit that that determines whether two moving images are similar to each other by comparing the feature values accumulated by the accumulating unit.

According to another aspect of an embodiment of the invention, an encoding device that encodes a moving image to generate moving image data, includes: a transforming unit that performs discrete cosine transform on an image constituting a moving image and including a two-dimensional arrangement of a plurality of pixels; a quantization unit that quantizes an image of a coefficient obtained as a result of the discrete cosine transform by the transforming unit; a calculating unit that calculates a feature value indicating complexity of an image based on a data amount of a frame obtained by quantization by the quantization unit and a quantization step used in the quantization; and an accumulating unit that accumulates the feature value of each image calculated by the calculating unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram of a configuration of main components of a similarity determination device according to a first embodiment of the present invention;

FIG. 2 is a schematic diagram of a hierarchical structure of moving image data according to the first embodiment;

FIG. 3 is a flowchart of operations of the similarity determination device according to the first embodiment;

FIG. 4 illustrates an example of a chronological change in a feature value according to the first embodiment;

FIG. 5 is a flowchart of similarity determination processing according to the first embodiment;

FIG. 6 illustrates a specific example of the similarity determination processing according to the first embodiment;

FIG. 7 is a block diagram of a configuration of main components of an encoding device according to a second embodiment of the present invention; and

FIG. 8 is a schematic diagram of encoding of a moving image in the MPEG format.

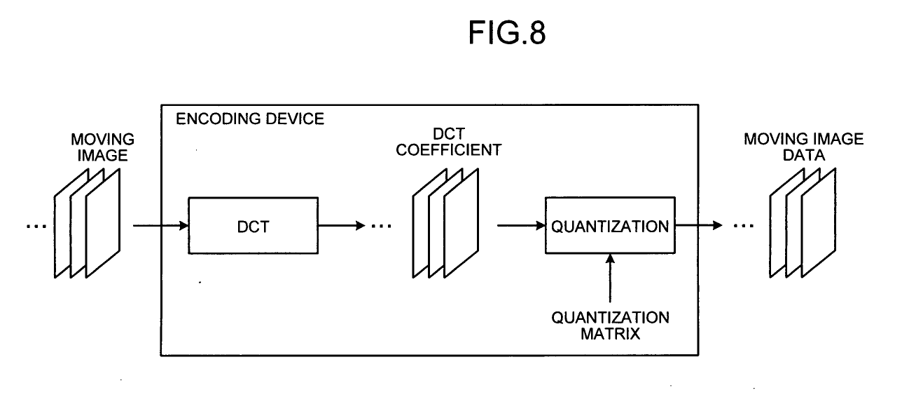

### DESCRIPTION OF EMBODIMENT(S)

In essence, in the present invention, feature values indicating complexity of original images are calculated from a data amount of each frame of moving image data and a quantization step used for quantization of the frame, and similarity between moving images is determined by comparing the feature values. Preferred embodiments of the present invention will be explained with reference to accompanying drawings.

### [a] First Embodiment

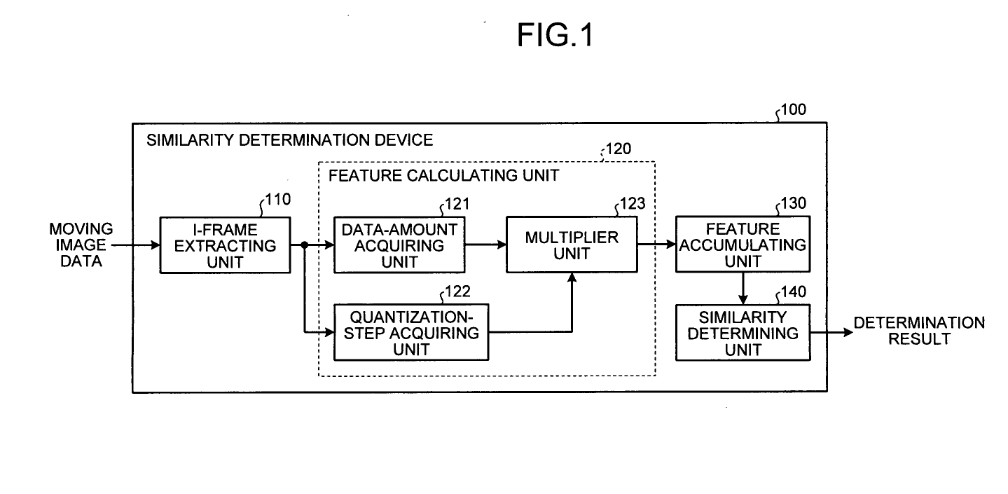

FIG. 1 is a block diagram of a configuration of main components of a similarity determination device 100 according to a first embodiment of the present invention. The similarity determination device 100 illustrated in FIG. 1 includes an I-frame extracting unit 110, a feature calculating unit 120, a feature accumulating unit 130, and a similarity determining unit 140.

When moving image data to be determined for their similarity are input, the I-frame extracting unit 110 extracts an I frame that is obtained by encoding an entire image from the input moving image data. That is, the I-frame extracting unit 110 extracts only the I frame that is used in similarity determination, among the I frame, a P frame, and a B frame that are included in the moving image data, ignoring the P frame and B frame. Because the I frame is obtained by encoding the entire image, the I frame expresses a feature of the image best with the single frame alone.

The feature calculating unit 120 calculates a feature value of the moving image data from information related to the I frame. The feature calculating unit 120 calculates the feature value indicating complexity of the original image using header information of each layer constituting the moving image data, without performing an operation to calculate a coefficient for each pixel such as inverse quantization. Specifically, the feature calculating unit 120 includes a data-amount acquiring unit 121, a quantization-step acquiring unit 122, and a multiplier unit 123.

The data-amount acquiring unit 121 acquires a data amount of the I frame from header information of the I frame. As described later, the moving image data has a hierarchical structure including a plurality of layers, and header information added to each layer. The data-amount acquiring unit 121 acquires the data amount from the header information of the I frame that belongs to a picture layer. If conditions relating to the quantization of images are fixed, the greater the complexity of the original image is, the greater the data amount of a frame having been encoded becomes.

The quantization-step acquiring unit 122 acquires a quantization step of each macro block from header information of the macro block constituting the I frame. The quantization-step acquiring unit 122 calculates an average value of the quantization steps of the micro blocks, to output the average value to the multiplier unit 123. That is, the quantization-step acquiring unit 122 calculates an average value of the quantization steps used for encoding of the macro blocks from the header information in a macro block layer. If the data amounts of the macro bocks are constant, the greater the complexity of the original image is, the rougher the quantization being performed is and the greater the quantization step is.

The multiplier unit 123 multiplies the data amount of the I frame and the average value of the quantization steps of the respective macro blocks, to calculate a feature value of the I frame. As described, the data amount and the quantization step have a relation such that if one of them is fixed, the more complex the image is, the greater the other one becomes. Therefore, the larger the feature value acquired by multiplying these is, the more complex the original image of the I frame is.

The feature accumulating unit 130 accumulates the feature value of each I frame calculated by the feature calculating unit 120 in association with time information of the I frame. The time information of the I frame indicates, for example, a time period between the start time of the moving image data to that I frame.

Moreover, the feature accumulating unit 130 stores a feature value and time information of each I frame of moving image data to be compared (hereinafter, “comparison data”) in advance. The feature values of the comparison data may be the feature values that have been calculated at the time of encoding by another device and stored in the feature accumulating unit 130, or the feature values that have been calculated by the feature calculating unit 120 similarly to the moving image data and stored in the feature accumulating unit 130 beforehand.

The similarity determining unit 140 compares the feature value of the moving image data and the feature value of the comparison data, and determines whether original moving images of both data are similar to each other. Specifically, the similarity determining unit 140 compares a chronological change in the feature value of the moving image data with a chronological change in the feature value of the comparison data, and determines whether a difference between the feature values of the frames of every time point within a predetermined range is less than a predetermined threshold. The similarity determining unit 140 then determines that the original moving images of the moving image data and the comparison data are similar to each other if the differences in the feature values of the frames for all the time points are less than the predetermined threshold, and determines that the original moving images of the moving image data and the comparison data are not similar to each other if there is at least a frame whose difference of the feature value is equal to or greater than the predetermined threshold.

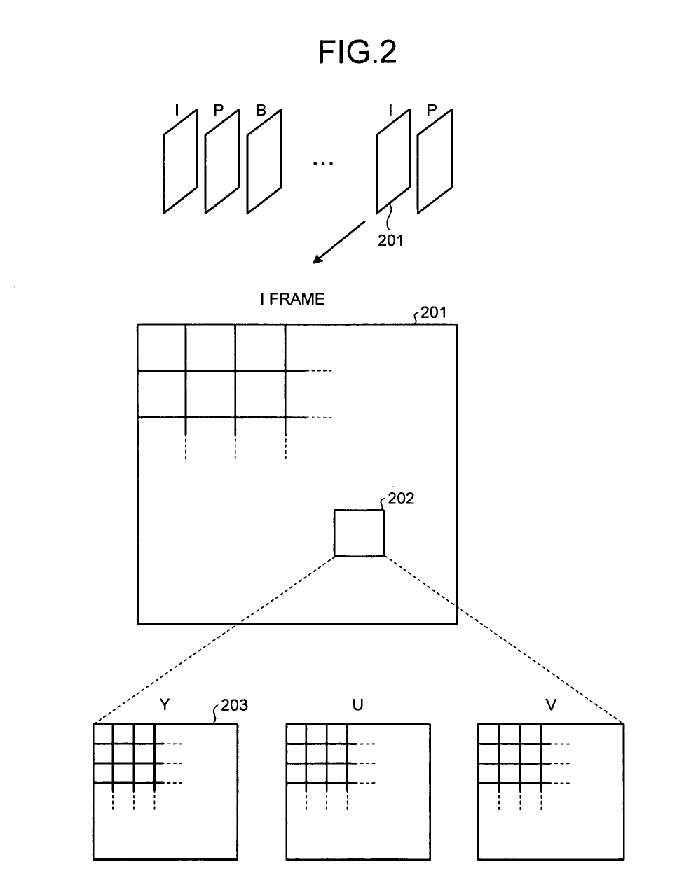

The hierarchical structure of moving image data according to the present embodiment is explained referring to FIG. 2. Moving image data belonging to a sequence layer include a plurality of frames that belong to the picture layer as illustrated at the top of FIG. 2. Frames include three types of frames, which are an I frame, a P frame, and a B frame. In the present embodiment, the I-frame extracting unit 110 extracts an I frame 201 from the moving image data.

In header information of the I frame 201, information such as a data amount of the I frame 201 and a quantization matrix that is used for quantization is stored. Therefore, the data-amount acquiring unit 121 acquires the data amount of the I frame 201 from the header information of the I frame 201. Between the sequence layer and the picture layer, a group of pictures (GOP) layer is present. A plurality of frames including an I frame belong to a GOP layer.

The I frame 201 belonging to the picture layer includes a plurality of macro blocks 202 that belong to the macro block layer as illustrated in the middle of FIG. 2. In header information of the macro blocks 202, information on quantization steps used upon quantization of the macro blocks 202 and the like are stored. Therefore, the quantization-step acquiring unit 122 acquires from the header information of each of the macro blocks 202 a quantization step of that macro block. Between the picture layer and the macro block layer, a slice layer is present, and to the slice layer, for example, macro blocks corresponding to one line belong.

A macro block 202 that belongs to the macro block layer includes a plurality of blocks 203, as illustrated at the bottom of FIG. 2. The blocks 203 are, for example, a block of a brightness signal (Y), a block of a difference between a brightness signal and a blue color component (U), a block of a difference between a brightness signal and a red color component (V), and the like, and are blocks having a size of 8×8 pixels, for example. In a pixel of each block 203, a coefficient is stored. However, in the present embodiment, the coefficients stored in the pixels are not used for the similarity determination.

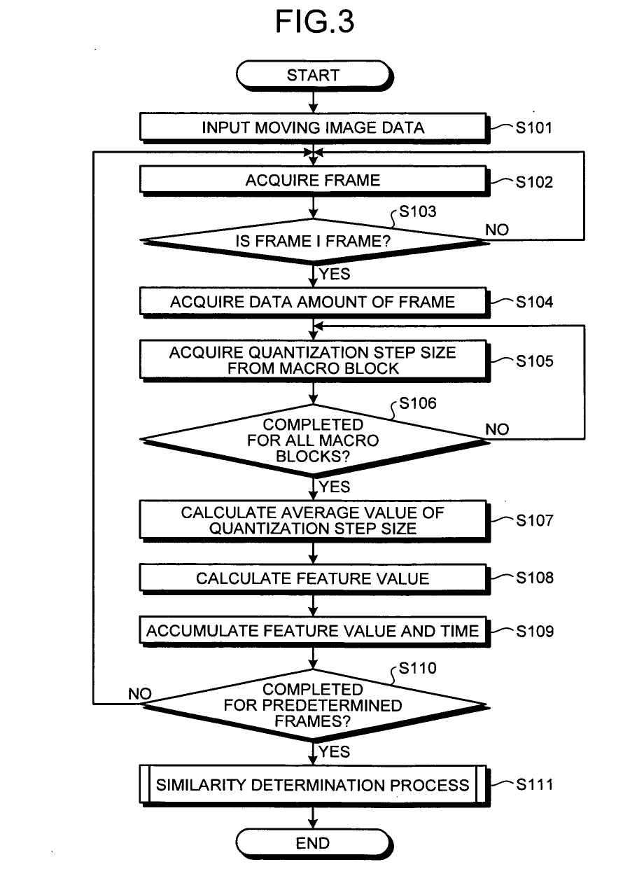

Subsequently, operations of the similarity determination device 100 configured as above are explained referring to a flowchart depicted in FIG. 3.

First, when moving image data are input to the similarity determination device 100 (step S101), the I-frame extracting unit 110 acquires an individual frame that constitutes the moving image data (step S102). It is then determined whether the acquired frame is an I frame (step S103), and if the frame is a P frame or a B frame and not the I frame (step S103: NO), a next frame is acquired.

If the frame acquired by the I-frame extracting unit 110 is an I frame (step S103: YES), this I frame is output to the data-amount acquiring unit 121 and the quantization-step acquiring unit 122. The data-amount acquiring unit 121 refers to header information of the I frame, and acquires a data amount of the frame (step S104).

The quantization-step acquiring unit 122 refers to header information of a plurality of macro blocks constituting the I frame, and acquires the quantization step used for quantization of each macro block (step S105). The quantization-step acquiring unit 122 determines whether quantization steps for all of the macro blocks constituting the I frame have been acquired (step S106). When the quantization steps have been acquired from the header information of all of the macro blocks (step S106: YES), an average value of the quantization steps is calculated (step S107).

The data amount and the average value of the quantization steps of the I frame are both output to the multiplier unit 123, and are multiplied by the multiplier unit 123 to calculate a feature value (step S108). Because this feature value is calculated only from the data amount and the quantization steps of the frame, an operation using information on each pixel or the like is not required. That is, because the feature value is calculated referring only to the header information of the picture layer and the header information of the macro block layer, workload and time for the calculation of feature value is small.

Furthermore, because the data amount and the quantization step have the relation such that if one of them is fixed, the greater the complexity of the original image is, the greater the other one becomes, the feature value indicates the complexity of the original image. That is, if the data amount is fixed, the more complex the image is, the rougher the quantization has to be to increase 0 pixels and thus the greater the quantization step is. If the quantization step is fixed, the more complex the image is, the greater the number of pixels that are not 0 is and thus the greater the data amount is. Accordingly, the feature value acquired by multiplying the data amount and the quantization step becomes larger as the complexity of the original image increases. At the same time, this feature value corresponds to a feature representing each frame, and feature values obtained from frames of similar images are close to each other.

The feature value calculated by the multiplier unit 123 is output to the feature accumulating unit 130, to be accumulated in association with time information of the I frame (step S109). While such calculation and accumulation of the feature values are being executed, the I-frame extracting unit 110 determines whether feature values for a predetermined number of frames from the moving image data have been accumulated (step S110). When the feature values for the predetermined number of frames have not been accumulated (step S110: NO), acquisition of frames from the moving image data is continued (step S102). The predetermined number of frames may be for all of the frames included in the moving image data. That is, the I-frame extracting unit 110 may extract all the I frames included in the moving image data to calculate the feature values from all the I frames.

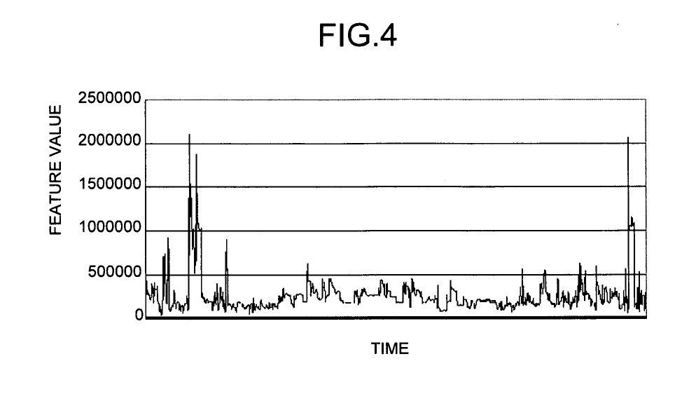

When the feature values related to the predetermined number of frames have been accumulated (step S110: YES), the similarity determining unit 140 compares the feature values of the moving image data and the comparison data, to perform the similarity determination processing (step S111). The similarity determination processing is performed, for example, by determining whether a chronological change in the feature value of the moving image data as depicted in FIG. 4 is similar to a chronological change in the feature value of the comparison data. The feature value of the comparison data may be a feature value that has been calculated by another device and stored in the feature accumulating unit 130 in advance, or a feature value that has been calculated by the feature calculating unit 120 similarly to the moving image data and stored in the feature accumulating unit 130 in advance.

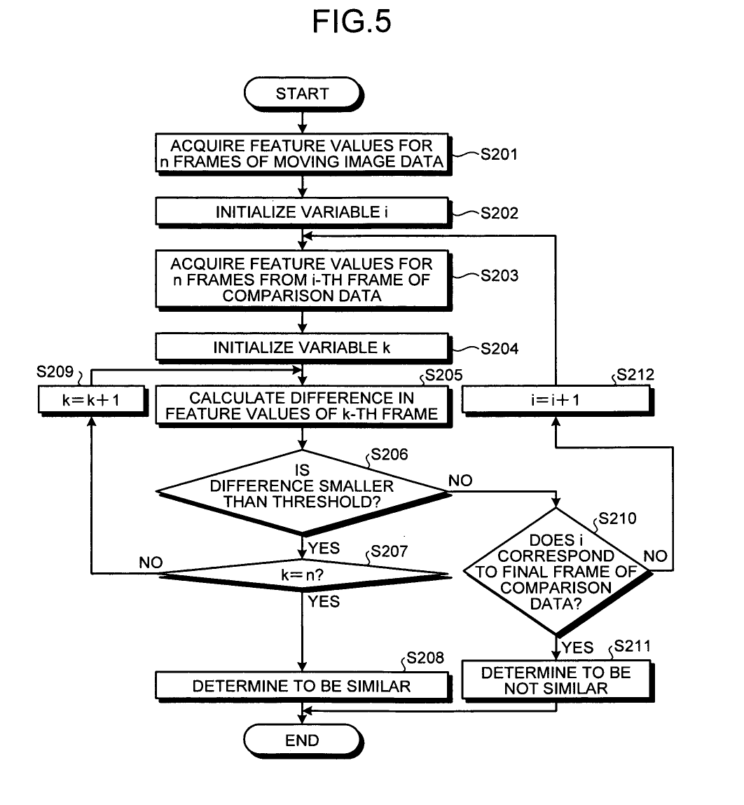

The similarity determination processing according to the present embodiment is explained below referring to the flowchart in FIG. 5 assuming that the chronological change in the feature value of the comparison data has been stored in the feature accumulating unit 130 in advance.

When the feature values for the predetermined number of frames (for example, all of the I frames in the moving image data) of the moving image data input to the similarity determination device 100 have been accumulated in the feature accumulating unit 130, the similarity determining unit 140 acquires the feature values of n frames (n is an integer equal to or greater than 1) of the moving image data from the feature accumulating unit 130 (step S201). The feature values of all the I frames of the moving image data may be acquired from the feature accumulating unit 130. The comparison data to be compared with the moving image data has n or more I frames, and the feature values of these I frames are accumulated in the feature accumulating unit 130.

The similarity determining unit 140 initializes a variable i to 1 (step S202). The variable i indicates a starting frame of a compared portion in the comparison data that is to be compared with the acquired n frames. That is, by the initialization of the variable i, the first to the n-th frames of the comparison data become the compared portion. Therefore, the similarity determining unit 140 acquires the feature values of n frames from i-th to (i+n−1)-th frames in the comparison data from the feature accumulating unit 130 (step S203).

When two kinds of feature values to be compared are thus acquired, the similarity determining unit 140 initializes a variable k to 1 (step S204). The variable k indicates a position of a frame in the compared portion. That is, by the initialization of the variable k, the feature values are compared from the initial (first) frame of the n frames. Specifically, the similarity determining unit 140 calculates a difference between the feature value of the k-th (in this example, the first) frame among the n frames of the moving image data and the feature value of the k-th (in this example, the first) frame from the compared portion of the comparison data (step S205). The k-th frame of the n frames of the moving image data and the k-th frame of the compared portion are frames having the same elapsed time from their respective starting frames.

The similarity determining unit 140 determines whether the difference between the feature values is smaller than a predetermined threshold (step S206). If the difference is smaller than the predetermined threshold (step S206: YES), it means that the feature of the k-th frame of the n frames is similar. Thus, the similarity determining unit 140 determines whether the variable k has become equal to n and the features of all of the n frames are similar (step S207). As described later, upon at least one frame of the n frames being determined to be not similar, it is determined that the n frames of the moving image data and the compared portion are not similar to each other. Therefore, upon determining that the feature of the n-th frame is similar, the features of all of the n frames would have been similar.

Accordingly, if it is determined that the variable k is equal to n as a result of comparing the variable k and n (step S207: YES), the n frames of the moving image data and the compared portion would have been similar to each other, and the similarity determining unit 140 determines that the moving image data and the comparison data are similar to each other (step S208). If the variable k is not equal to n (step S207: NO), the variable k is incremented by 1 (step S209), and the similarity determining unit 140 calculates a difference of feature value of the next frame and determines whether the difference is smaller than the predetermined threshold (steps S205, S206).

If, as a result of the comparison between the difference of feature value and the predetermined threshold, the difference is equal to or larger than the predetermined threshold (step S206: NO), this means that the feature of the k-th frame of the n frames is not similar. Therefore, the similarity determining unit 140 determines that the n frames of the moving image data and the compared portion are not similar to each other. As described, because it is determined that the n frames of the moving image data and the compared portion are not similar to each other upon occurrence of a frame whose feature is not similar, it is not necessary to perform comparison of feature values related to the remaining frames of the n frames, and thus time for the similarity determination is shortened.

Furthermore, if it is determined that the n frames of the moving image data and the compared portion are not similar to each other and all frames from the starting frame to the last frame of the comparison data have already become the compared portion, it is determined that a compared portion similar to the n frames of the moving image data has not been detected from the comparison data. Therefore, the similarity determining unit 140 determines whether the variable i is a value corresponding to the last frame of the comparison data (step S210). In other words, it is determined whether the (i+n−1)-th frame, which is the last frame of the compared portion, is the final frame of the comparison data.

As a result of this determination, if the variable i is the value corresponding to the final frame of the comparison data (step S210: YES), a compared portion that is similar to the n frames of the moving image data would not have been included in the comparison data, and the similarity determining unit 140 determines that the moving image data and the comparison data are not similar to each other (step S211). If the variable i is not the value corresponding to the final frame of the comparison data (step S210: NO), the variable i is incremented by 1 (step S212), and the similarity determining unit 140 determines n frames to be the compared portion in the comparison data, and feature values of this compared portion are acquired (step S203).

As described, in the present embodiment, n consecutive frames in the comparison data become the compared portion in turn, and the feature values thereof are compared with those of the n frames of the moving image data. When the compared portion for which the differences of feature values of all of the n frames are smaller than the predetermined threshold is included in the comparison data, it is determined that the moving image data and the comparison data are similar to each other. The feature values used for the comparison are acquired from the header information of the picture layer and the header information of the macro block layer, and the compared portion is changed upon determining that at least one frame included in the compared portion is not similar to the frame of the moving image data. Therefore, even for comparison data of a comparatively long time period, the similarity determination with respect to moving image data is speedily performed.

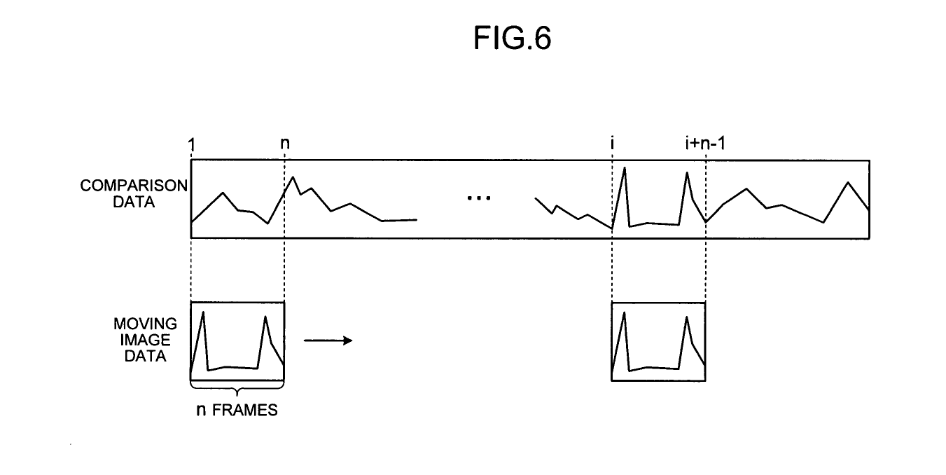

Next, a specific example of the similarity determination processing performed by the similarity determining unit 140 is explained referring to FIG. 6.

In the present embodiment, the feature values of the comparison data are stored in the feature accumulating unit 130 in advance, and the similarity determination between the moving image data and comparison data is performed based on whether a pattern similar to a chronological change in the feature values of the moving image data is included in a chronological change of these feature values. That is, when the feature value of the comparison data changes as expressed in the chronological change depicted in FIG. 6, a pattern of the chronological change in the feature value for the n frames of the moving image data is compared with a pattern of the chronological change in the feature value of the n consecutive frames in the comparison data, and if a pattern of the chronological change similar to that of the n frames of the moving image data is included in the comparison data, it is determined that the moving image data and the comparison data are similar to each other.

In the example depicted in FIG. 6, after the patterns of the chronological changes in the feature values of the n frames of the moving image data and the first to the n-th frames of the comparison data are compared, the compared portion to be compared with the n frames of the moving image data are gradually slid. Because the pattern of the chronological change in the feature value of the i-th to (i+n−1)-th frames of the comparison data is similar to the pattern of the chronological change in the feature value of the n frames of the moving image data, it is determined that the moving image data and the comparison data are similar to each other.

As described, according to the present embodiment, the data amount of the I frame and the quantization step of each macro block are acquired from the header information included in the I frame of the moving image data, and the feature value indicating the complexity of the original image of the I frame is calculated by multiplying the data amount and the average value of the quantization steps. By comparing these chronological changes in the feature values, whether a plurality of images are similar to each other is determined. Therefore, it is not required to calculate a feature value of the original image by calculating a value for each pixel of the moving image data, and thus the feature value is easily calculated. Because the calculation of the feature value is easy, the similarity comparison of moving images using this feature value is efficiently performed in a short period of time.

In the first embodiment described above, in the similarity comparison processing, the feature values of respective frames of the n frames of the moving image data and the compared portion are compared, and it is determined that the n frames of the moving image data and the compared portion are not similar to each other upon occurrence of a frame having a difference of feature value equal to or greater than the predetermined threshold. However, even if there is a frame whose difference of feature value is equal to or larger than the predetermined threshold, the feature values may be compared for all of the n frames, to make the similarity determination for the n frames of the moving image data and the compared portion based on a proportion of frames whose differences of feature values are equal to or greater than the predetermined threshold to the n frames. Although this increases the time period required for the similarity determination, a range to be determined similar is increased, and even stricter similarity determination is enabled.

Moreover, in the first embodiment described above, the similarity determination processing is performed by comparing a difference of feature value for each frame with a predetermined threshold. However, a statistical value such as an average value, a maximum value, a minimum value, a standard deviation, or the like in each chronological change of feature values of a predetermined number of frames of the moving image data and the comparison data may be calculated instead, to perform the similarity comparison processing by comparing the calculated statistic values. That is, the moving image data and the comparison data may be determined to be similar to each other, if the difference between the statistical values is smaller than a predetermined threshold, for example.

### [b] Second Embodiment

A second embodiment of the present invention is characterized in that feature values of an original moving image are accumulated at the time of encoding to create moving image data.

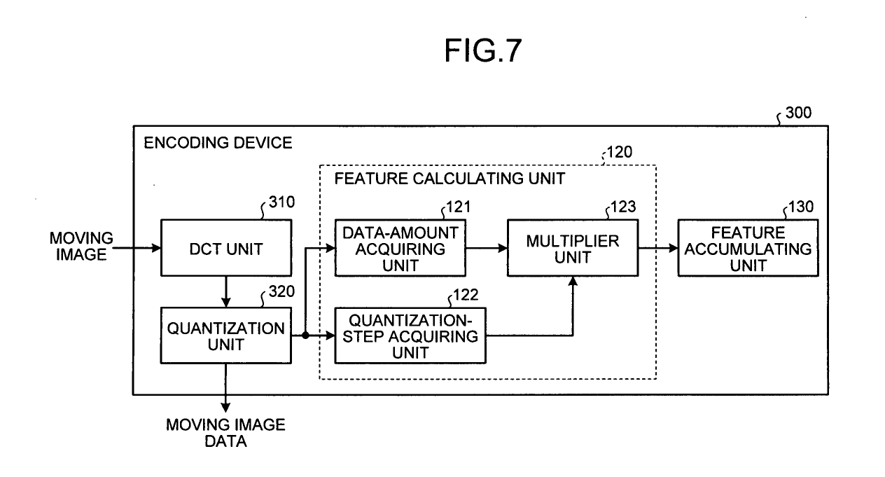

FIG. 7 is a block diagram of a configuration of main components of an encoding device 300 according to the second embodiment. In FIG. 7, like reference numerals refer to components that are the same as those in FIG. 1, and the explanation therefor is omitted. The encoding device 300 illustrated in FIG. 7 includes a DCT unit 310, a quantization unit 320, the feature calculating unit 120, and the feature accumulating unit 130.

The DCT unit 310 performs DCT on individual images constituting a moving image, and an image of DCT coefficients in which low-frequency components are stored in pixels in an upper left part and high-frequency components are stored in pixels in a lower right part is created. The DCT unit 310 performs the DOT on a plurality of images that correspond to respective blocks that belong to a block layer, such as an image of a brightness signal, an image of a difference between a brightness signal and a blue color component, and an image of a difference between a brightness signal and a red color component. The images of the blocks thus obtained are micro blocks belonging to the macro block layer as a set.

The quantization unit 320 performs quantization on the image of the DCT coefficients generated by the DCT unit 310 using a quantization matrix and a quantization step. The quantization unit 320 adjusts the quantization step for each macro block, to make the data amount of each I frame constant. The quantization unit 320 stores information on the quantization step of each macro block in the header of the macro block layer, and stores information on the data amount of the I frame in the header of the picture layer.

In the present embodiment, the feature calculating unit 120 acquires the data amount of each image and the quantization step of each macro block to calculate a feature value of each image when the individual images constituting the moving image are encoded for generating moving image data. That is, the data-amount acquiring unit 121 acquires the data amount of the I frame from the quantization unit 320, the quantization-step acquiring unit 122 acquires the quantization step of each macro block from the quantization unit 320, and the multiplier unit 123 multiplies the data amount and the average value of the quantization steps.

The feature value thus calculated is accumulated in the feature accumulating unit 130 in association with time information of the I frame similarly to the first embodiment. The feature values thus accumulated may be used to determine whether there is a moving image that is similar to a moving image that has been encoded by the encoding device 300. Specifically, for example, the feature values accumulated in the feature accumulating unit 130 at the time of encoding a moving image may be used as the feature values of the comparison data in the first embodiment. That is, by combining the similarity determination device 100 of the first embodiment and the encoding device 300 of the present embodiment, feature values of the comparison data may be accumulated at the time of generating moving image data from a moving image, and this makes it unnecessary to calculate the feature values of the comparison data anew when the similarity determination is performed for the comparison data and other moving image data.

As described above, according to the present embodiment, when a moving image is encoded to generate moving image data, the data amount of an I frame and the quantization step of each macro block are acquired to calculate a feature value indicating the complexity of an original image of the I frame by multiplying the data amount and the average value of the quantization steps. Therefore, the feature values of the moving image are calculated to be accumulated at the time of encoding, and thus the accumulated feature values are usable in the determination of similarity between the accumulated feature values and the feature values of other moving image data, thereby improving the processing efficiency.

Although in each of the embodiments described above, a feature value is calculated by multiplying a data amount of an I frame and an average value of quantization steps, the feature value may be calculated by an operation other than multiplication. That is, the data amount and the quantization step have the relation such that if one of them is fixed, the greater the complexity of the original image is, the greater the other one becomes, and therefore, an operation may be performed to determine how large generally the two kinds of information, i.e., the data amount and the quantization step are. Further, if multiplication is performed, each information may be weighted.

Moreover, although in each of the embodiments described above, the quantization-step acquiring unit 122 acquires quantization steps of all of macro blocks in an I frame to calculate an average value thereof, quantization steps of only some of the macro blocks may be acquired to calculate the average value thereof. This enables to further shorten the processing time to calculate a feature value, and to perform the similarity determination and the like more efficiently.

According to an embodiment of the invention, a feature value of an image is calculated from a data amount and a quantization step of a frame. Therefore, it is not necessary to perform an operation for each pixel of the moving image data to calculate the feature value, and thus the feature value of the moving image data is easily calculated, and similarity determination for moving images by comparison of their feature values is efficiently performed in a short period of time.

According to an embodiment of the invention, a feature value is calculated by multiplying a data amount and a quantization step of a frame. Therefore, from these two values, i.e., the data amount and the quantization step, which have a relation such that if one of them is fixed, the greater the complexity of the image is, the greater the other one becomes, the feature value is calculated that is larger if the image is more complex.

According to an embodiment of the invention, information on the data amount is acquired from header information of a frame. Therefore, information for calculating the feature value is acquired from a header of a picture layer, and the feature value is calculated in a short period of time.

According to an embodiment of the invention, a feature value is calculated using an average value of quantization steps of macro blocks. Therefore, even when the quantization steps of the macro blocks in a frame are different, the feature value of each image corresponding to a frame is calculated.

According to an embodiment of the invention, information on a quantization step is acquired from header information of a macro block. Therefore, information for calculating the feature value is acquired from a header of a macro block layer, and the feature value is calculated in a short period of time.

According to an embodiment of the invention, two moving images are determined to be similar to each other if the feature values indicating complexity of the images are similar. Therefore, once the feature values for the two moving images have been calculated, the determination of similarity is performed easily.

According to an embodiment of the invention, similarity determination processing is performed by comparing statistical values calculated form feature values. Therefore, the similarity determination is performed by an easy process of comparing a part or all of an average value, a minimum value, a maximum value, and a standard deviation in a chronological change in the feature values, for example.

According to an embodiment of the invention, a feature value of an image is calculated and accumulated from a data amount and a quantization step of a frame obtained upon encoding of a moving image. Therefore, by using the accumulated feature values in the similarity determination with respect to feature values of other moving image data, the processing efficiency is improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A moving-image similarity determination device comprising:
an acquiring unit that acquires a frame included in moving image data obtained by encoding a moving image including a plurality of images, the frame corresponding to an individual image of the plurality of images;
a calculating unit that calculates a feature value indicating complexity of an original image of the frame based on a data amount of the frame acquired by the acquiring unit and on a quantization step used upon encoding;
an accumulating unit that accumulates the feature value calculated for each image by the calculating unit; and
a determining unit that that determines whether two moving images are similar to each other by comparing the feature values accumulated by the accumulating unit.

2. The moving-image similarity determination device according to claim 1, wherein the calculating unit includes:
a data-amount acquiring unit that acquires the data amount of the frame acquired by the acquiring unit;
a quantization-step acquiring unit that acquires the quantization step used upon encoding of the frame acquired by the acquiring unit; and
a multiplier unit that multiplies the data amount acquired by the data-amount acquiring unit and the quantization step acquired by the quantization-step acquiring unit.

3. The moving-image similarity determination device according to claim 2, wherein
the data-amount acquiring unit acquires the data amount from header information of the frame acquired by the acquiring unit.

4. The moving-image similarity determination device according to claim 2, wherein
the quantization-step acquiring unit acquires the quantization step that is different for each macro block of a plurality of macro blocks constituting the frame acquired by the acquiring unit, and
the multiplier unit multiplies the data amount acquired by the data-amount acquiring unit and an average value of the quantization steps of the plurality of macro blocks each acquired by the quantization-step acquiring unit.

5. The moving-image similarity determination device according to claim 4, wherein the quantization-step acquiring unit acquires the quantization step of each of the plurality of macro blocks from header information of the macro block.

6. The moving-image similarity determination device according to claim 1, wherein the determining unit determines that the two moving images are similar to each other if a difference between the feature value accumulated by the accumulating unit and a feature value of a moving image to be compared is less than a predetermined threshold.

7. The moving-image similarity determination device according to claim 1, wherein the determining unit determines whether the two moving images are similar to each other by comparing a statistical value calculated from the feature value accumulated by the accumulating unit and a statistical value calculated from a feature value of a moving image to be compared.

8. An encoding device that encodes a moving image to generate moving image data, the encoding device comprising:
a transforming unit that performs discrete cosine transform on an image constituting a moving image and including a two-dimensional arrangement of a plurality of pixels;
a quantization unit that quantizes an image of a coefficient obtained as a result of the discrete cosine transform by the transforming unit;
a calculating unit that calculates a feature value indicating complexity of an image based on a data amount of a frame obtained by quantization by the quantization unit and a quantization step used in the quantization; and
an accumulating unit that accumulates the feature value of each image calculated by the calculating unit.

9. A feature calculating method comprising:
acquiring a data amount of a frame included in moving image data obtained by encoding a moving image including a plurality of images, the frame corresponding to an individual image of the plurality of images;
acquiring a quantization step used upon encoding of the frame; and
calculating a feature value indicating complexity of an original image of the frame based on the data amount acquired and the quantization step acquired.
